(19) United States
(12) Patent Application Publication
(10) Pub. No.: US 2008/0277233 A1
(43) Pub. Date: Nov. 13, 2008

(54) Clutch for a Motor Vehicle

(75) Inventor: Horst Hamann, Russelsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/093,808

(22) PCT Filed: Nov. 15, 2006
(86) PCT No.: PCT/EP2006/010936

§ 371 Date: May 15, 2008

(30) Foreign Application Priority Data
Nov. 16, 2005 (DE) 10 2005 054 450.9

(51) Int. Cl. F16D 13/38

(52) U.S. Cl. 192/70.14

(57) ABSTRACT

In a clutch for a motor vehicle comprising a first (1) and a second shaft (4), a first (2) and a second (11) plate, which are connected in a manner fixed against relative rotation to the first shaft (1) and of which the first plate (8) has a higher thermal capacity than the second plate (11) and of which at least one plate (11) is axially displaceable in order to clamp a clutch disc (7), which is connected in a manner fixed against relative rotation to the second shaft (4) and which is provided on both sides with a wear layer (8, 9), between the two plates (8, 11), the wear layer (9) on the side facing the second plate (11) is thicker than the wear layer (8) on the side facing the first plate (2).

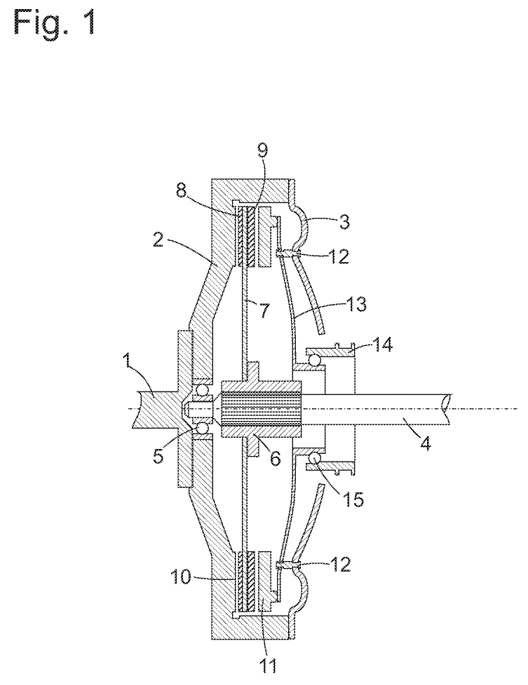

### CROSS-REFERENCE TO RELATED APPLICATIONS

This application is a U.S. National-Stage entry under 35 U.S.C. § 371 based on International Application No. PCT/EP2006/010936, filed Nov. 15, 2006, which was published under PCT Article 21(2) and which claims priority to German Application No. 102005054450.9, filed Nov. 16, 2005, which are all hereby incorporated in their entirety by reference.

### TECHNICAL FIELD

The present invention relates to a clutch for the drive train of a motor vehicle as well as to an automated shift transmission, in which such a clutch is used.

### BACKGROUND

In recent years an automated shift transmission has been developed by the name of “Easytronic”, in which a control unit instead of the driver, controls the shift movements required for a change of gear in a shift transmission. The control unit assists fully automatic gear selection in dependence upon the instantaneous driving situation as well as gear selection according to the input of the driver, who no longer has to actuate a clutch pedal or a gearshift lever but merely actuates touch controls to signal his request for a gear change to the control unit. The control unit then actuates a clutch actuator in order to open a clutch of the shift transmission, a transmission actuator in order to engage a selected gear, and then the clutch actuator again in order to close the clutch.

The automated shift transmission has advantages both over a conventional manual shift transmission, because it relieves the driver of control tasks, such as for example, measured use of the clutch during starting, disengagement and engagement of the clutch during gear changing and disengagement of the clutch when stopping, and over a conventional automatic transmission, because it has a lower specific fuel consumption and enables flexible shift characteristics according to the wish of the driver. A starting speed, which is higher than that conventionally used by an experienced driver with a manual shift transmission, enables a uniform, jolt-free start similar to that achieved with an automatic transmission.

In view of the foregoing, at least one object of the invention is to provide a clutch for an automated shift transmission that has an extended useful life. In addition, other objects, desirable features, and characteristics will become apparent from the subsequent summary, detailed description, and the appended claims, taken in conjunction with the accompanying drawings and this background.

### SUMMARY

The at least one object, other objects, desirable features and characteristics, are achieved according to an embodiment of the invention by a clutch for a motor vehicle comprising a first and a second shaft, a first and a second plate, which are connected in a manner fixed against relative rotation to the first shaft and of which the first plate has a higher thermal capacity than the second plate and of which at least one plate is axially displaceable in order to clamp a clutch disc, which is connected in a manner fixed against relative rotation to the second shaft and which is provided on both sides with a wear layer, between the two plates, and wherein the wear layer is thicker on the side facing the second plate than on the side facing the first plate.

In a conventional clutch for a manual shift transmission, the clutch disc on both sides carries wear layers of equal thickness, which wear out uniformly in line with the fact that the friction heat arising during closing of the clutch occurs in a substantially equal quantity at both wear layers. Since, of the two plates that clamp the clutch disc, the movable plate generally has the smaller mass and hence the lower thermal capacity, on its side a greater degree of heating is to be expected. As the wear of the wear layers increases more than linearly with temperature, an increased abrasion is to be expected at the clutch disc facing the plate with the lower thermal capacity. This is compensated according to the an embodiment of the invention by selecting different thicknesses for the wear layers on the two sides of the clutch disc. It is thereby possible to achieve the effect that both approximately simultaneously reach a minimum thickness, at which they have to be exchanged. The useful life of the wear layers is therefore extended without their overall thickness and hence the moment of inertia of the clutch having to be increased for this purpose.

The optimal factor, by which the wear layer facing the second plate should be thicker than the wear layer facing the first plate depends within specific limits upon the conditions of use, in particular the starting speed, and upon the exact values of thermal capacity and thermal conductivity of the two plates and may be optimized experimentally. Generally, it has proved advantageous to make the wear layer on the side of the clutch disc facing the second plate thicker by at least a factor of about 1.2 and at most a factor of about 1.7 than on the side facing the first plate.

### BRIEF DESCRIPTION OF THE DRAWING

The present invention will hereinafter be described in conjunction with the following drawing figures, wherein like numerals denote like elements, and

### DETAILED DESCRIPTION

The following detailed description is merely exemplary in nature and is not intended to limit any application and uses. Furthermore, there is no intention to be bound by any theory presented in the preceding background of the invention or the following detailed description.

The single FIGURE shows a diagrammatic section through a single-disc clutch according to an embodiment of the invention. An engine-side first shaft 1 carries a flywheel 2 that is fixed against relative movement rotationally and in axial direction. Fastened to the periphery of the flywheel 2 is a clutch cover 3. A transmission-side second shaft 4 engages into the housing formed by flywheel 2 and clutch cover 3 and is held coaxially with the first shaft 1 by means of a rolling contact bearing 5, which is accommodated in a bore of the flywheel 2 and in turn accommodates an end journal of the shaft 4.

A sleeve 6, which is positively slipped or pressed onto the second shaft 4, carries a resilient clutch disc 7. In an outside edge region of the clutch disc 7 linings 8 and/or 9 are adhered or riveted. The lining 8 facing a clamping jaw 10 of the flywheel 2 has, for example, a thickness of about ca. 1 mm; the opposite lining 9 facing an annular clutch thrust plate 11 is about ca. 1.5 mm thick.

In the closed state of the clutch, the clutch thrust plate 11 is pressed by means of a cup spring 13, which is pivotable on pins 12, against the flywheel 2 so that the clutch disc 7 is clamped in tightly between flywheel 2 and thrust plate 11 and transmits the rotation of the first shaft 1 to the second shaft 4. In the illustrated position, the cup spring 13 is deformed by means of a release device 14 that transmits a force, which is exerted by a non-illustrated declutching fork and directed axially to the left in the FIGURE, via a roller thrust bearing 15 to the cup spring 13 and hence holds the clutch open.

From the FIGURE it is easy to comprehend that, if the declutching fork actuated by an electronic control unit moves back to the right, the cup spring 13 presses the thrust plate 11 against the clutch disc 7, so that the clutch disc 7 moves back against the flywheel 2 and is finally clamped between thrust plate 11 and flywheel 2. The friction heat produced during closing of the clutch is substantially the same on both sides of the clutch disc 7, because of the compared to the flywheel 2 low weight and correspondingly lower thermal capacity of the thrust plate 11 the friction heat may spread only to a limited extent in the thrust plate 11, so that the lining 9 heats up to a markedly greater extent than the lining 8.

The ratio of the thicknesses of the linings 8, 9 is selected in such a way that, taking the temperature-related difference of the wear of the linings 8, 9 into account, an identical useful life is achieved for both linings 8, 9. A thickness ratio of between about 1.2 and about 1.7 is advantageous, a value of ca. 1.5 being preferred.

The embodiment of the invention may also be applied to a double-disc clutch. Such a clutch comprises between flywheel and thrust plate two clutch discs, which are rotationally fixed on the second shaft, and between these an axially movable plate, which is connected in a rotationally fixed manner to the housing formed by the flywheel and the clutch cover. Here too, the components, between which in each case one of the clutch discs is clamped, may differ considerably in their thermal capacity, thereby leading to a different heating and accordingly different wear of the linings on opposite sides of the clutch discs, so that the lining on the side of the clutch disc facing the component with the lower thermal capacity should be made thicker than the one on the opposite side.

While at least one exemplary embodiment has been presented in the foregoing detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A clutch for a motor vehicle, comprising:
a first and a second shaft; and
a first and a second plate connected in a manner fixed against relative rotation to the first shaft and of which the first plate has a higher thermal capacity than the second plate,
wherein at least one of the first and second plates is axially displaceable in order to clamp a clutch disc connected in a manner fixed against relative rotation to the second shaft and which is provided on both sides with a wear layer between the two plates, and
wherein the wear layer on the side facing the second plate is thicker than the wear layer on the side facing the first plate.

2. The clutch according to claim 1, wherein the first plate is axially fixed.

3. The clutch according to claim 1, wherein the wear layer is thicker by at least a factor of about 1.2 on the side facing the second plate than on the side facing the first plate.

4. The clutch according to claim 1, wherein the wear layer is thicker by at most a factor of about 1.7 on the side facing the second plate than on the side facing the first plate.

5. (canceled)
